(19) United States
(12) Patent Application Publication
(10) Pub. No.: US 2008/0303686 A1
(43) Pub. Date: Dec. 11, 2008

(54) Remote blind opening and closing system

(76) Inventor: Rick Mosbrucker, Templeton, CA (US)

Correspondence Address: LAW OFFICES OF ANDREW SCHROEDER, P.O. Box 6731, Santa Maria, CA, 93454, US

(21) Appl. No.: 11/810,531

(22) Filed: Jun. 5, 2007

(51) Int. Cl. E06B 9/32; G08C 17/02

(52) U.S. Cl. 340/825; 160/168.1 P

(57) ABSTRACT

A remote blind actuating system for use in opening and closing blinds with a wand incorporates: a motor a drive shaft, a gear box, a receiver, and a housing. The motor, the drive shaft, and the receiver are disposed within the housing. The motor is connected with the drive shaft and is in communication with the receiver. The drive shaft is an elongate member with a first distal end and a second distal end. The first distal end of the drive shaft is connected with the motor and the second distal end is connected with the gearbox.

### FIELD OF THE INVENTION

The present invention relates with a system and apparatus for opening and closing window blinds.

### BACKGROUND OF THE INVENTION

One of the most popular fixtures are window blinds. Window blinds are desirable for their ability to brighten up a room by opening the blinds. They are also used to darken a room thereby shielding sunlight from the room. These blinds are typically opened and closed by a wand. This wand is an elongate member which is twisted to open or close the blinds.

One of the lesser known benefits of the use of blinds is their ability to save energy. By shutting the blinds during daylight hours, a home or building may greatly reduce its air conditioning costs during summer months. Conversely, in the winter months the heating costs of a home or building may be significantly reduced by simply allowing sunlight to enter through the windows by opening the blinds. It is estimated that between 50-65% of all energy costs in many industrialized nations are directly attributable to heating and air conditioning costs. Therefore, the simple act of opening and closing the blinds can have a significant impact on utilities bills.

In addition, newer technologies are currently entering the market which utilize various home-related macros. These home-actuating macros are computer-operated systems which control environmental conditions or entertainment options without the need for a user to self-actuate various appliances. These home-actuating macros can turn on a television set when a user walks in his home. They can modulate a thermostat to rise or fall during the day to user's preferences for comfort and for economic savings. A home-actuating macro would be more useful if they could open or close the blinds throughout the day to save on energy costs for the user.

Unfortunately, in the marketplace there does not exist an cost-effective apparatus for opening and closing blinds remotely. In order to open and close blinds one must physically turn the wand of the blinds to open and close them.

Therefore, what is clearly needed in the art is a system and apparatus for opening and closing blinds remotely. The system and apparatus should be user-friendly, compact, and discreet in order to not affect the aesthetic tastes of a user.

### SUMMARY OF THE INVENTION

It is an object of the present invention to provide a system and apparatus for opening and closing blinds remotely. The system and apparatus will enable a user to open and close blinds completely open, completely shut, and any intermediate position to modulate the amount of light to come through the window.

It is an object of the present invention to provide for a compact system and apparatus for the purpose of being discreetly affixed to the blinds so as not to affect the aesthetics of the blinds.

### BRIEF DESCRIPTION OF THE DRAWING FIGURES

FIG. 1 is a perspective view of a preferred embodiment of the present invention.

FIG. 2 is a perspective view of a preferred embodiment of the present invention.

FIG. 3 is a perspective view of a preferred embodiment of the present invention.

FIG. 4 is a perspective view of a preferred embodiment of the present invention.

FIG. 5 is a perspective view of a preferred embodiment of the present invention.

FIG. 6 is a perspective view of a preferred embodiment of the present invention.

FIG. 7a is a side view of a preferred embodiment of the present invention.

FIG. 7b is a perspective view of a preferred embodiment of the present invention.

FIG. 7c is a planar view of a preferred embodiment of the present invention.

FIG. 8 is a planar and side view of a preferred embodiment of the present invention.

### DESCRIPTION OF PREFERRED EMBODIMENTS

According to a preferred embodiment of the present invention, a unique system and apparatus are used to open and close blinds remotely.

The present invention is described in enabling detail below.

For the purposes of the present invention the term “blind” or the term “slat” shall hereinafter refer to those individual horizontal members which are rotated by the wand of the blind system. Moreover, for the purposes of the present invention the term “vertical mechanism box” refers to the system which integrates the wand, the strings (or other analogous parts), and other pieces which enable one to pull up the blinds, let the blinds fall, or to rotate the blinds.

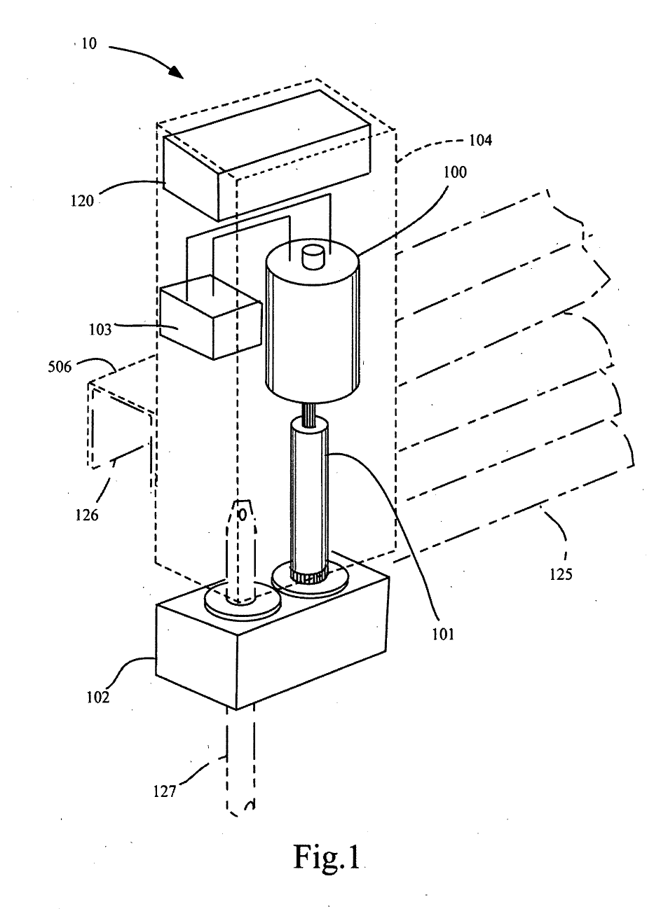

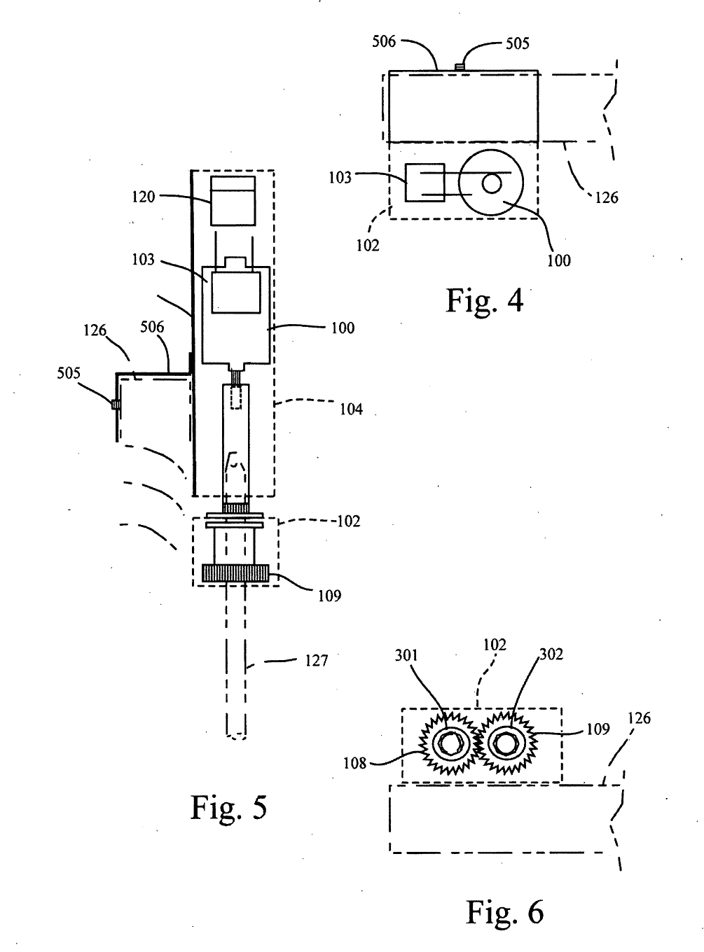

FIG. 1-6 illustrate a preferred embodiment of the present invention. A remote blind actuating system 10 for use in opening and closing blinds with a wand incorporates: a motor 100, a drive shaft 101, a gear box 102, a receiver 103, and a housing 104. In addition, for illustration purposes, the blinds or slats are denoted as 125, the wand is denoted as 127, and the vertical mechanism box is denoted as 126. The vertical mechanism box is typically found on the top of most blind systems and is typically obscured by the valance. FIG. 1 also illustrates that the system may further comprise a battery 120 in some preferred embodiments. The battery is disposed within the housing and is in communication with the motor.

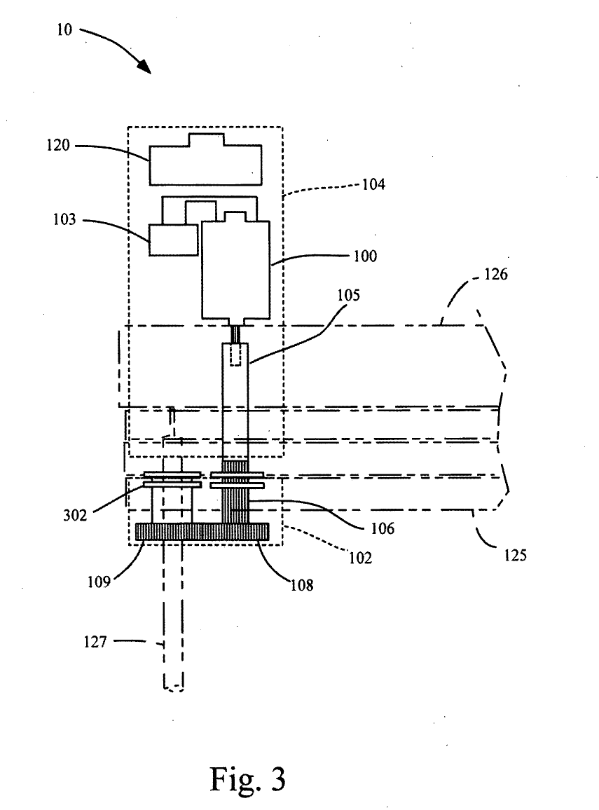

The motor, the drive shaft, and the receiver are disposed within the housing. The motor is connected with the drive shaft and is in communication with the receiver. The drive shaft is an elongate member with a first distal end 105 and a second distal end 106 as illustrated in FIG. 3. The first distal end of the drive shaft is connected with the motor and the second distal end is connected with the gear box.

FIGS. 5-6 illustrate that the gear box 102 is comprised of a first reciprocating gear 108 and a second reciprocating gear 109. The first reciprocating gear and the second reciprocating gear are disposed within the gear box. The first reciprocating gear is connected with the second distal end of the drive shaft and the second reciprocating gear is connected with the wand of the blind system.

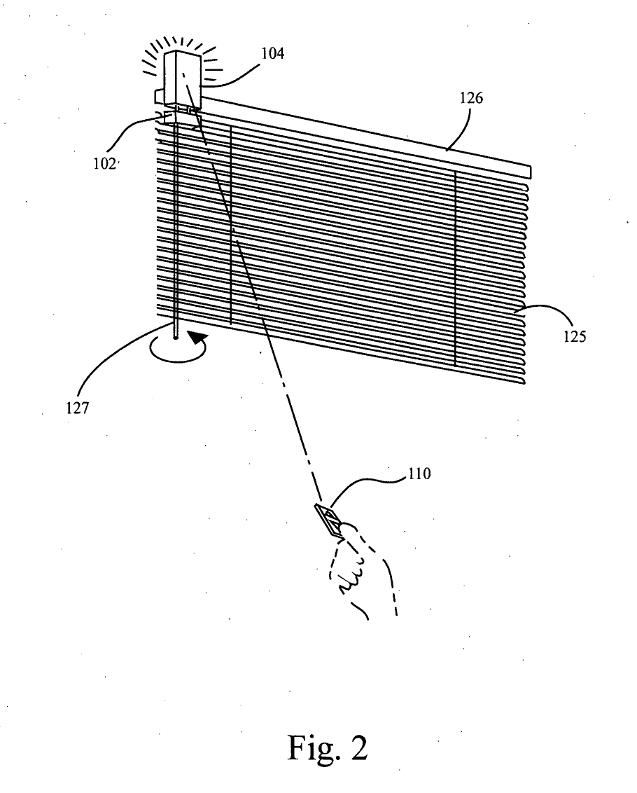

FIG. 2 also illustrates how the system works operationally. A remote control 110 is used to actuate the system from a distance. The remote control may work either through radio waves, laser, infrared, or other expedient means. It may also be possible for the remote control to be physically connected by a wire to the receiver of the system. For these reasons, the type of remote control to be used with the present invention should not be construed to be limiting the scope of the present invention.

It should be noted that the remote control may have an “open” button, a “closed” button, an “up” button, and a “down” button. The open button would actuate the blinds so the blinds are completely open to allow for maximum sunlight to traverse the glass. The closed button would completely close the blinds in order to block out all sunlight. And the up/down buttons would enable the user to choose an intermediate position in between.

It should also be noted that the present invention may also be adaptable for use with various home-macro systems which can modulate various conditions or entertainment devices within the home. In this case the present invention may not necessarily need a remote control, but would instead be either directly wired into the system or would be in communication with the system by radio or other frequency. The options are endless.

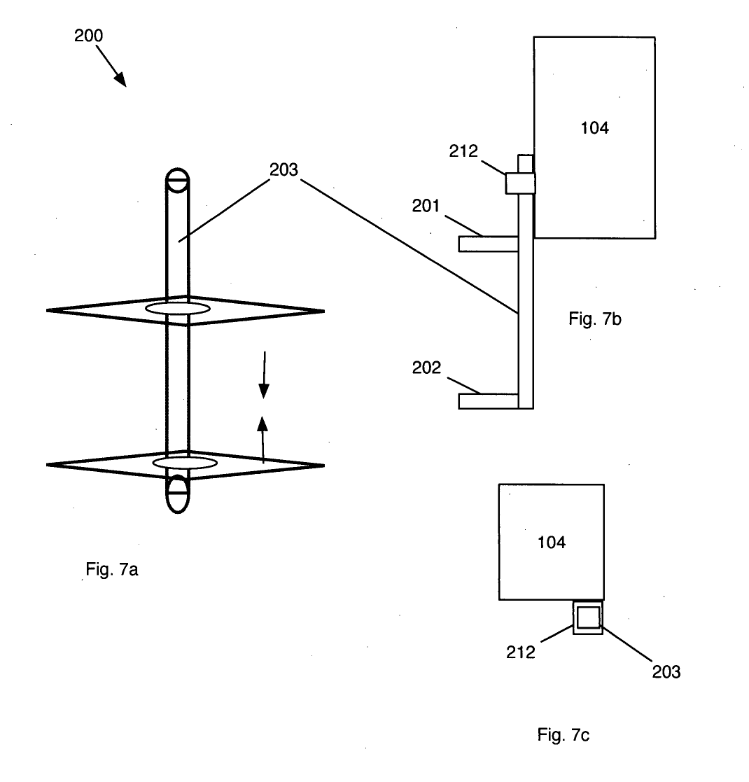

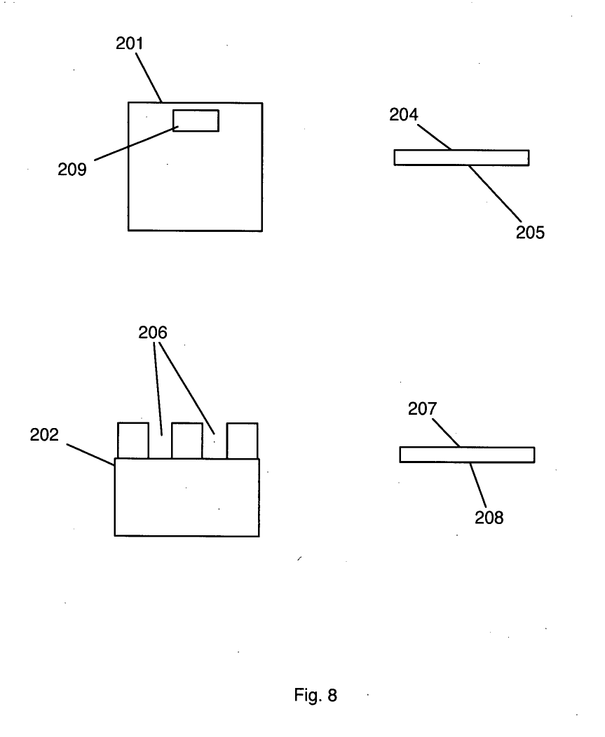

FIG. 7a-c illustrates a preferred embodiment wherein the system may further comprise an attachment apparatus 200 for affixing the system with the blinds. The attachment apparatus is comprised of a first planar member 201, a second planar member 202, and at least one track member 203. FIG. 8 illustrates that the first planar member has a first side 204, a second side 205, and at least one orifice 209. The second planar member has a top side 207, a bottom side 208, and at least one slot 206. Moreover, in some preferred embodiments, FIG. 7b illustrates that the attachment apparatus may further incorporate a guide 212 affixed to the housing for the purpose of guiding the track members.

The first side of the first planar member abuts the housing. The first planar member is disposed above the second planar member. The track member is disposed longitudinally through the orifice of the first planar member and the slot of the second planar member. The track member is affixed to the housing.

In operation, the attachment apparatus works by sandwiching a portion of the vertical mechanism box by creating converging pressure between the planar members as illustrated by the arrows in FIG. 7a. Attachment apparatus is scalable to any size blinds due to the track member, which enables user to modulate the distance between the planar members as they are translated along the track members.

FIG. 5 illustrates another preferred embodiment wherein another attachment 506 apparatus is illustrated. This attachment apparatus is comprised of a long right-angled (or possibly other angles) member for clipping on to the vertical mechanism box or other suitable area. It may also incorporate a set screw 505 for the purpose of affixation with the vertical mechanism box. There may be other means of affixation with the blind system. For this reason, the present invention is not necessarily limited to a specific type of means of affixation.

FIG. 6 illustrates that in some preferred embodiments the system may further include a drive shaft gasket 300 and/or a wand gasket 301. The drive shaft gasket is disposed longitudinally in the first reciprocating gear whereas the wand gasket is disposed longitudinally in the second reciprocating gear. In some preferred embodiments these gaskets may be made of rubber or other suitable flexible and resilient material. In addition, the system may further comprise washers 302 in some preferred embodiments.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A remote blind actuating system for use in opening and closing blinds with a wand comprising:
a motor, a drive shaft, a gear box, a receiver, and a housing;
the motor, the drive shaft, and the receiver are disposed within the housing;
the motor is connected with the drive shaft and is in communication with the receiver;
the drive shaft is an elongate member with a first distal end and a second distal end;
the first distal end of the drive shaft is connected with the motor and the second distal end is connected with the gear box;
the gear box is comprised of a first reciprocating gear and a second reciprocating gear;
the first reciprocating gear is connected with the second distal end of the drive shaft and the second reciprocating gear is connected with the wand of the blind system.

2. The system of claim 1 further comprising a remote control for the purpose of communicating with the receiver.

3. The system of claim 2 wherein the remote control utilizes radio frequency.

4. The system of claim 1 further comprising an attachment apparatus;
the attachment apparatus for use in affixing the remote blind actuating system with the blinds;
the attachment apparatus is comprised of a first planar member, a second planar member, and at least one track member;
the first planar member has a first side, a second side, and at least one orifice;
the second planar member has a top side, a bottom side, and at least one slot;
the first side of the first planar member abuts the housing;
the first planar member is disposed above the second planar member;
the track member is disposed longitudinally through the orifice of the first planar member and the slot of the second planar member;
the track member is affixed to the housing.

5. The system of claim 1 further comprising a battery; the battery is disposed within the housing and is in communication with the motor.

6. The system of claim 1 further comprising a wand gasket; the wand gasket is disposed longitudinally in the second reciprocating gear.

7. The system of claim 1 further comprising a driveshaft gasket; the drive shaft gasket is disposed longitudinally in the first reciprocating gear.

8. The system of claim 4 wherein the attachment apparatus comprises at least two track members.

9. The system of claim 7 wherein the drive shaft gasket is made of rubber.

10. The system of claim 6 wherein the wand gasket is made of rubber.
